(19) United States
(12) Patent Application Publication
(10) Pub. No.: US 2010/0008712 A1
(43) Pub. Date: Jan. 14, 2010

(54) FLUID FLOW COUPLING ASSEMBLY AND SYSTEM

(75) Inventors: Dean E. Sitz, Wahpeton, ND (US); Trevor J. Stav, Wahpeton, ND (US); Jason Hanzlik, Wahpeton, ND (US)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: ComDel Innovations Inc., Wahpeton, ND (US)

(21) Appl. No.: 12/501,268

(22) Filed: Jul. 10, 2009

Related U.S. Application Data
(60) Provisional application No. 61/079,706, filed on Jul. 10, 2008.

(51) Int. Cl. F16C 11/00; F16L 43/00

(52) U.S. Cl. 403/65; 285/181

(57) ABSTRACT

A fluid flow coupling assembly includes an inlet housing defining an inlet channel communicating with a first bushing recess and an outlet housing defining an outlet channel communicating with a second bushing recess. The assembly includes a bushing defining a flow bore communicating between the inlet channel and the outlet channel and a first bushing section disposed in the first bushing recess and a second bushing section disposed in the second bushing recess. The inlet and outlet housings are coupled to the bushing such that the inlet housing rotates about the bushing independently from the outlet housing. The first bushing section is retained between opposing walls of the first bushing recess and the second bushing section is retained between opposing walls of the second bushing recess.

### CROSS-REFERENCE TO RELATED APPLICATIONS

This application claims priority under 35 U.S.C. §119(e)(1) to U.S. Provisional Patent Application Ser. No. 61/079,706, filed Jul. 10, 2008, entitled “Suction Coupling Assembly and System”, and bearing Attorney Docket No. C840.102.101; and the entire teachings of which are incorporated herein by reference.

### BACKGROUND

Fluid flow devices generally include a fluid flow source (e.g., suction source or pressurized air source) and some form of tubing coupled between the fluid flow source and the fluid flow device. When using the fluid flow device, the operator typically moves the fluid flow device from one area of interest to another area of interest. The movement of the fluid flow device has the potential to tangle the tubing and possibly impinge the tubing, thus reducing fluid flow. In addition, the movement of the fluid flow device has the potential to tug components of the device apart and possibly disengage the tubing from the device. When the fluid flow source is a high vacuum source used manually for extended duration, the weight and inflexibility of the tubing has the potential to fatigue the operator's wrist and arms. When the fluid flow source is a pressurized air source used manually for extended duration, the weight and flexibility of the tubing has the potential to fatigue the operator's wrist and arm.

It is desirable to provide improvements to fluid flow device assemblies that minimize tubing tangling, device disengagement, and user fatigue.

### SUMMARY

One embodiment provides a fluid flow coupling assembly that includes an inlet housing defining an inlet channel communicating with a first bushing recess and an outlet housing defining an outlet channel communicating with a second bushing recess. The assembly includes a bushing defining a flow bore communicating between the inlet channel and the outlet channel and a first bushing section disposed in the first bushing recess and a second bushing section disposed in the second bushing recess. The inlet and outlet housings are coupled to the bushing such that the inlet housing rotates about the bushing independently from the outlet housing. The first bushing section is retained between opposing walls of the first bushing recess and the second bushing section is retained between opposing walls of the second bushing recess.

### BRIEF DESCRIPTION OF THE DRAWINGS

The accompanying drawings are included to provide a further understanding of the disclosure and are incorporated in as a part of this specification. The drawings illustrate example embodiments and together with the description serve to explain principles of the disclosure. Other embodiments and many of the intended advantages of the embodiments will be readily appreciated as they become better understood by reference to the following detailed description. The elements of the drawings are not necessarily to scale relative to each other. Like reference numerals designate corresponding similar parts.

FIG. 1 is perspective view of a fluid flow system including a fluid flow device communicating with fluid flow tubing and including a fluid flow coupling that enables the fluid flow device to rotate and move relative to the fluid flow tubing according to one embodiment.

FIG. 2 is a perspective view of the fluid flow coupling shown in FIG. 1 according to one embodiment.

FIG. 3 is a cross-sectional view of the fluid flow coupling shown in FIG. 2 according to one embodiment.

FIG. 4 is an exploded perspective view of the fluid flow coupling shown in FIG. 2 according to one embodiment.

FIGS. 5A and 5B provide two views of a portion of an inlet housing retaining a portion of a bushing according to one embodiment.

FIG. 6 is a perspective view of a fluid flow coupling according to another embodiment.

FIG. 7 is a cross-sectional view of the fluid flow coupling shown in FIG. 6 according to one embodiment.

FIG. 8 is an exploded perspective view of the fluid flow coupling shown in FIG. 6 including O-rings that couple with a bushing according to one embodiment.

FIG. 9 is an exploded perspective view of the fluid flow coupling shown in FIG. 8 showing the O-rings coupled to the bushing according to one embodiment.

FIG. 10 is a top view of the fluid flow coupling shown in FIG. 6 having top portions of the inlet housing and the outlet housing removed according to one embodiment.

FIG. 11 is an exploded perspective view of a fluid flow coupling according to another embodiment.

FIGS. 12A and 12B provide two views of the fluid flow coupling shown in FIG. 11 having a top portion of an inlet housing removed to show a bushing received within a bushing recess of the inlet housing according to one embodiment.

### DETAILED DESCRIPTION

In the following Detailed Description, reference is made to the accompanying drawings which form a part hereof, and in which is shown by way of illustration specific embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments of the present disclosure can be positioned in a number of different orientations, the directional terminology is used for purposes of illustration and is in no way limiting. It is to be understood that other embodiments may be utilized and structural or logical changes may be made without departing from the scope of the present disclosure. The following detailed description, therefore, is not to be taken in a limiting sense.

Embodiments provide a fluid flow coupling assembly including a housing that is rotatably coupled around a bushing. A “fluid” as used herein is intended to include any type of gas or liquid. The fluid flow coupling may be used with any type of fluid, including air and water. The bushing is configured to provide an internal spring force that presses portions of the bushing against internal walls of the housing to minimize or eliminate leakage of liquids and air that flow through the bushing and the housing. The bushing and the housing are configured to enable a first housing portion to rotate around the bushing independently of a second housing portion. In this manner, an inlet side of the fluid flow coupling is enabled to rotate freely relative to an outlet side of the fluid flow coupling to provide free movement of a handheld fluid flow device relative to its tubing.

In one embodiment, the bushing is provided without O-rings and provides a wide range of rotational motion for the fluid flow coupling while surprisingly minimizing or eliminating leakage through the fluid flow coupling. In another embodiment, the bushing includes O-rings that are captured between flanges of the bushing and configured to reduce or eliminate the risk of liquid or air leakage. Other embodiments provide a bushing having one or more washers and one or more O-rings that combine to seal the bushing inside of the housing.

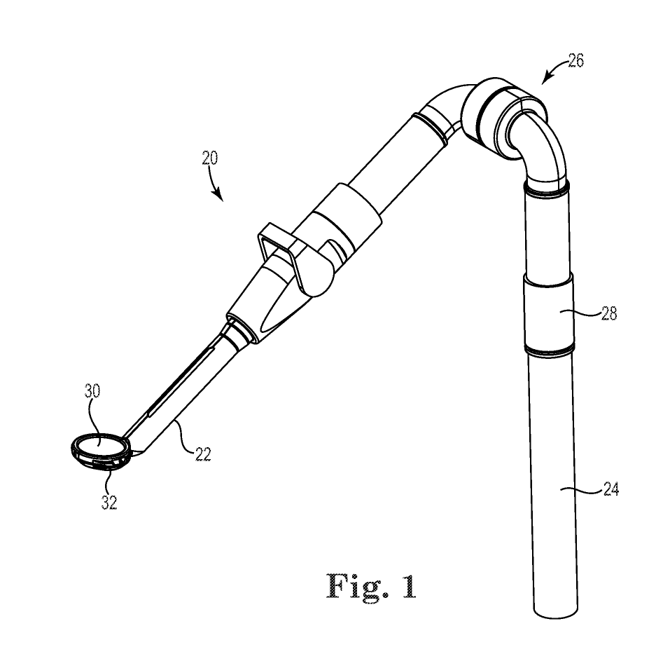

FIG. 1 is a perspective view of a fluid flow system 20 according to one embodiment. Fluid flow system 20 includes a fluid flow device 22 in fluid communication with a fluid flow tube 24 that is coupled to a fluid flow source (not shown) and a fluid flow coupling 26 coupled between the fluid flow device 22 and fluid flow tube 24. In one embodiment, fluid flow system 20 is a suction system, device 22 is a suction device, tube 24 is a suction tube, and the fluid flow source is a suction source. In another embodiment, fluid flow system 20 is a pressurized air system, device 22 is a pressurized air device, tube 24 is a pressurized air tube, and the fluid flow source is a pressurized air source. In other embodiments, fluid flow system 20 may be another type of fluid flow system, and the fluid flow source may be either a negative pressure source (e.g., suction) or a positive pressure source (e.g., blowing/compressed air). Fluid flow coupling 26 is configured to enable fluid flow device 22 to rotate relative to fluid flow tube 24 while minimizing or eliminating leakage of liquids aspirated through the fluid flow device 22.

In one embodiment, system 20 optionally includes an axial swivel 28 coupled between fluid flow tube 24 and fluid flow coupling 26. Axial swivel 28 enables fluid flow coupling 26 to rotate on-axis relative to fluid flow tube 24, thereby providing another degree of freedom for movement of system 20. Suitable axial swivels 28 include those described in U.S. patent application Ser. No. 12/110,488, entitled “SUCTION COUPLING SYSTEM AND ASSEMBLY,” filed on Apr. 28, 2008 and incorporated herein in its entirety.

Fluid flow device 22 includes any suitable fluid flow device. In one embodiment, fluid flow device 22 is a dental suction device including a mirror surface 30 and a suction area 32. The fluid flow device 22 includes general suction devices, hazardous waste suction devices, particle suction devices, liquid suction devices, dental suction devices, such as ULTRAVIEW® available from DentaVations, Inc., Fargo, N. Dak., and air flow devices that use positive or negative pressure airflows. Other suitable fluid flow devices are also acceptable.

In one embodiment, the fluid flow source to which fluid flow tube 24 is attached provides a vacuum ranging from about 5-15 inches Hg. The fluid flow tube 24 includes high suction tubing employed in dental offices, low suction tubing, or Tygon plastic tubing available from Polymer Plastics Corp., Reno, Nev. One example of suitable tubing includes asepsis dental tubing available from KAB Dental, Sterling Heights, Mich. Other forms of tubing, and other fluid flow devices, are also acceptable.

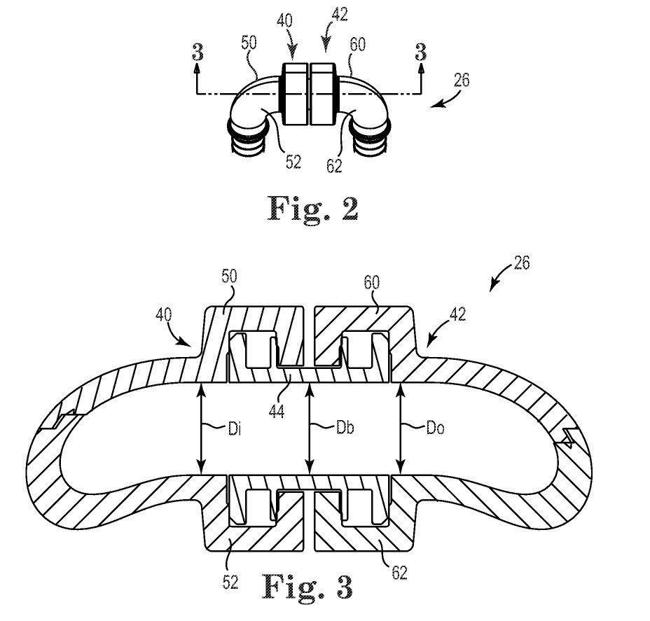

FIG. 2 is a perspective view of fluid flow coupling 26 and FIG. 3 is a cross-sectional view of fluid flow coupling 26 taken through line 3-3 as shown in FIG. 2. Fluid flow coupling 26 includes an inlet housing 40 and an outlet housing 42, each independently rotatably coupled around a bushing 44. In one embodiment, inlet housing 40 includes a first housing section 50 coupled to a second housing section 52, and outlet housing 42 includes a first housing section 60 coupled to a second housing section 62. First housing sections 50, 60 are coupled to respective second housing sections 52, 62 in any suitable manner, such as ultrasonic welding. When assembled, inlet housing 40 surrounds a portion of bushing 44 and outlet housing 42 is spaced apart from inlet housing 40 and also surrounds a portion of bushing 44. In this manner, inlet housing 40 is configured to rotate freely and separately from outlet housing 42, while both housings 40, 42 provide a fluid-seal around bushing 44.

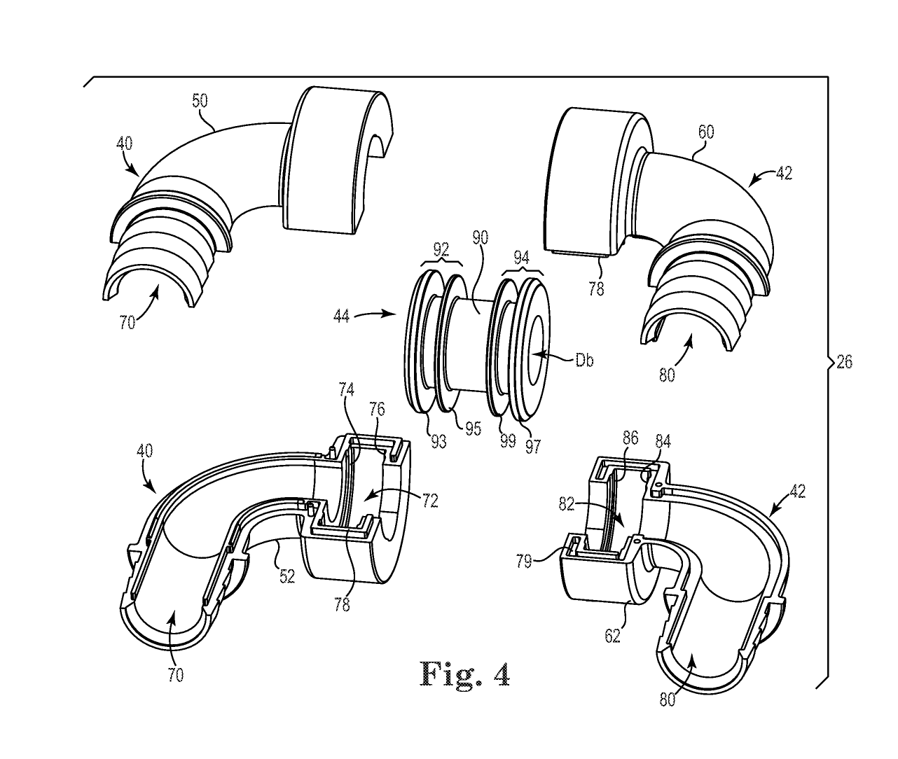

In one embodiment, inlet housing 40 defines an inside diameter Dᵢ, outlet housing 42 defines an inside diameter Dₒ, and bushing 44 defines an inside bushing diameter D_{b}, where the diameters Dᵢ, Dₒ, D_{b} are substantially equal. In this manner, the flow path through inlet housing 40 across bushing 44 and through outlet housing 42 is a substantially constant diameter flow path that is configured to minimize the disruption in flow of liquids moving through fluid flow coupling 26. The smooth and substantially constant inside flow diameter is characterized by an absence of steps/bumps in the flow path such that noise resulting from the flow is reduced. In addition, the substantially constant inside flow diameter reduces cavitation and resonant noise in the coupling. In one embodiment, an entirety of inlet channel 70 (FIG. 4), outlet channel 80 (FIG. 4), and the flow bore defined by the inside diameter D_{b} are linearly aligned within fluid flow coupling 26.

Suitable plastics for fluid flow coupling 26 include thermoplastic Acetal, nylon, nylon 6, nylon 6,6, polyetherimide, and polyolefins such as high density polyethylene, polypropylene, polyester, and acrylonitrile-butadiene-styrene (ABS). As an example, some nylons and polyetherimide plastics are autoclavable. Other suitable non-leaching and non-corrosive materials are also acceptable for fabricating fluid flow coupling 26.

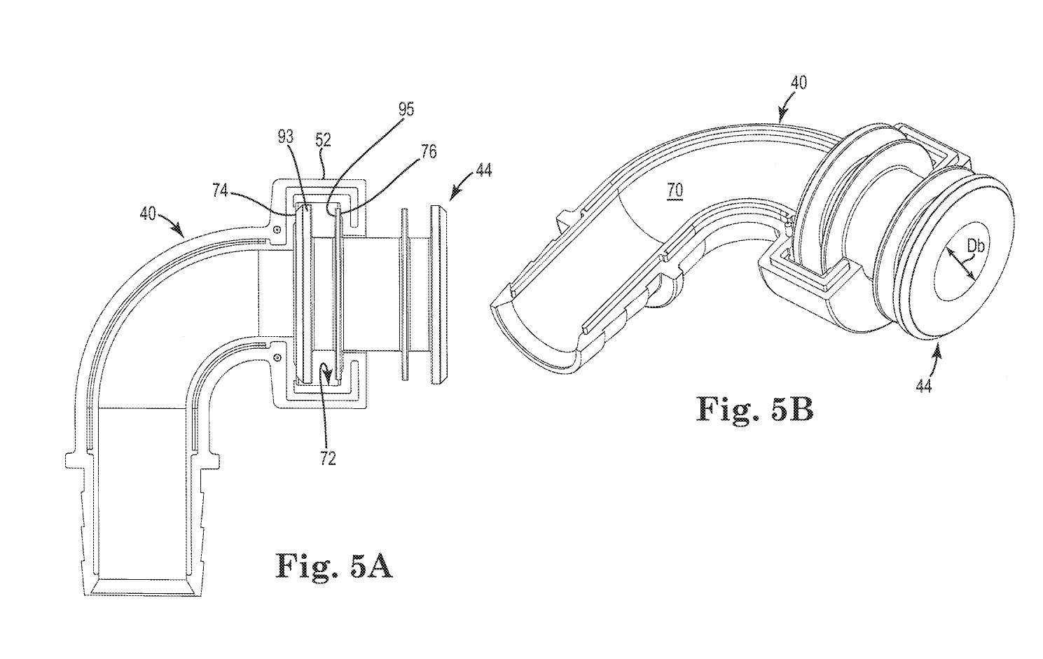

FIG. 4 is an exploded perspective view of fluid flow coupling 26 and FIGS. 5A and 5B provide two views of bushing 44 engaged with bushing recess 72 of inlet housing 40. In general, inlet housing 40 is similar to outlet housing 42. Inlet housing 40 includes an inlet channel 70 communicating with a bushing recess 72 that is formed between opposing interior walls 74, 76. Outlet housing 42 defines an outlet channel 80 communicating with a bushing recess 82 formed between opposing internal walls 84, 86. Although channels 70, 80 are illustrated as having a bend, it is to be understood that other embodiments of channels 70, 80 provide “straight-through” flow channels, or liner flow channels. That is to say, fluid flow coupling 26 is not limited in the flow path that it provides.

In one embodiment, one section of each one of the housings 40, 42 is molded to include a fence 78 that is received within a trough 79 provided by an opposing section of the housings 40, 42. Fence 78 is inserted into trough 79 and aligns the first housing section with the second housing for each of the housings 40, 42. Subsequent to this assembly, the housings 40, 42 are suited for ultrasonic welding or other forms of coupling that encloses housings 40, 42 over bushing 44.

In one embodiment, bushing 44 includes an axle 90 (FIG. 4) extending between a first bushing section 92 and a second bushing section 94. In one embodiment, first bushing section 92 includes a first flange 93 spaced from a second flange 95, and second bushing section 94 includes a first flange 97 spaced from a second flange 99. The bushing sections 92, 94 provide an internal spring in which the flanges 93, 95, 97, 99 are pre-loaded to flex apart outwardly to frictionally contact respective walls 74, 76, 84, 86. For example, FIG. 5A illustrates that first flange 93 presses against wall 74 and second flange 95 presses against wall 76 to sealingly and rotatably couple bushing 44 into bushing recess 72. Second bushing section 94 (FIG. 4) functions in a similar manner. After assembly according to one embodiment, the inlet housing 40 encloses an entirety of the first bushing section 92, and the outlet housing 42 encloses an entirety of the second bushing section 94.

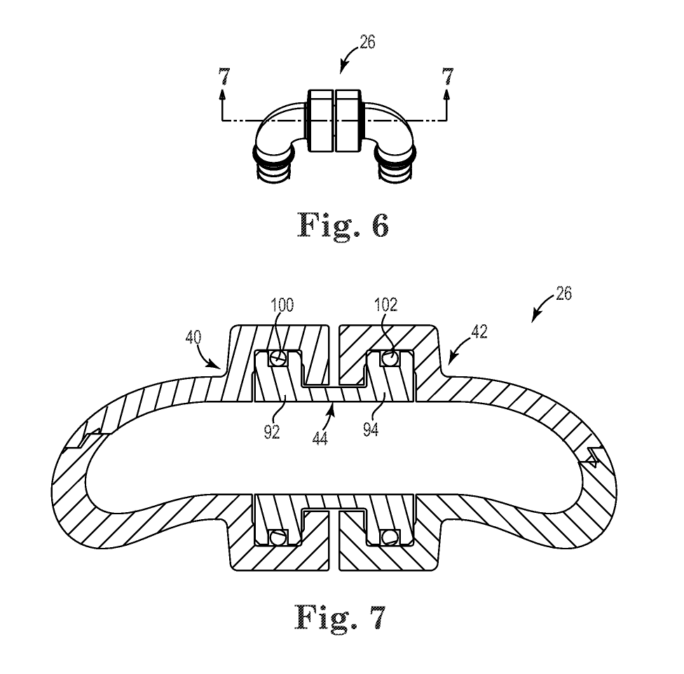

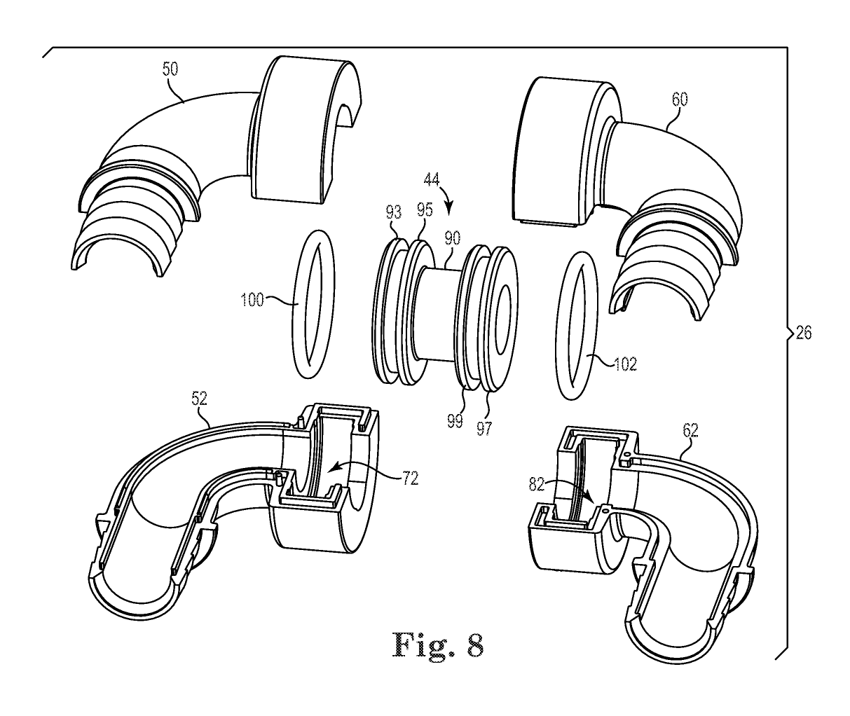

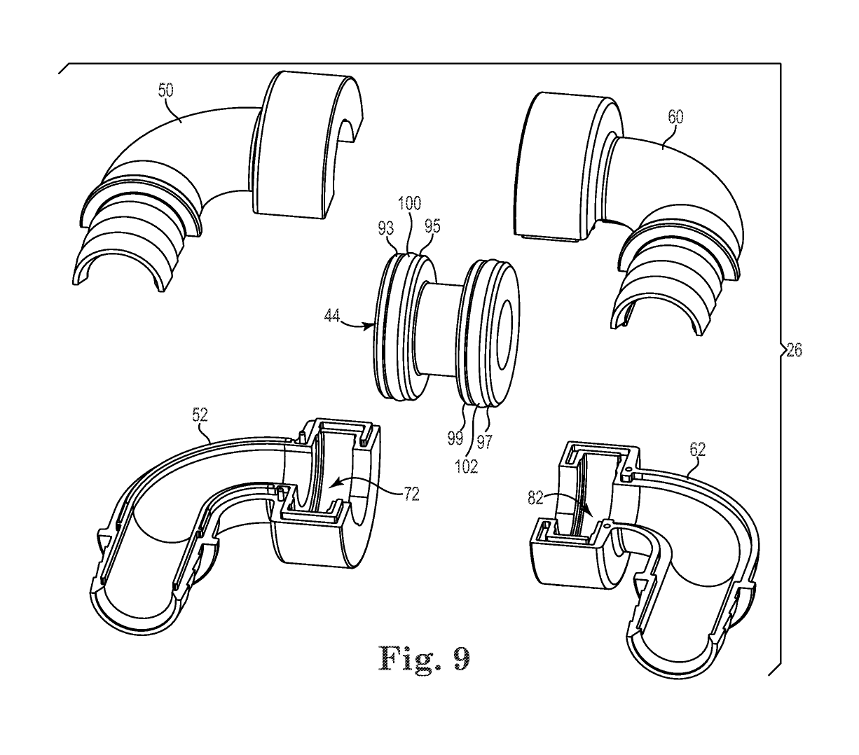

FIG. 6 is a perspective view and FIG. 7 is a cross-sectional view of fluid flow coupling 26 including optional O-rings 100, 102. The cross-sectional view of FIG. 7 is taken through line 7-7 in FIG. 6. FIG. 8 is an exploded perspective view of fluid flow coupling 26 showing O-rings 100, 102 separated from bushing 44, and FIG. 9 is an exploded perspective view of fluid flow coupling 26 showing O-rings 100, 102 coupled between flanges provided by bushing 44.

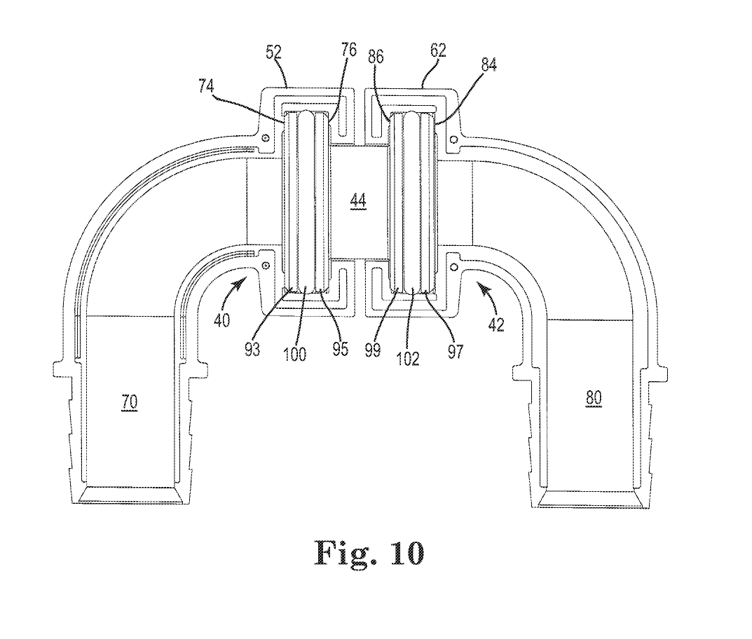

FIG. 10 is a top view of bushing 44 including optional O-rings 100, 102 seated within bushing 44 and bushing 44 seated within housings 40, 42. With reference to FIG. 9, O-ring 100 is received between flanges 93, 95, and O-ring 102 is received between flanges 97, 99. In one embodiment, flanges 93, 95 provide a spring-like force outward against walls 74, 76, respectively, and O-ring 100 is seated between flanges 93, 95 and configured to seal against an annular wall within bushing recess 72 (FIG. 9). In a similar manner, flanges 97, 99 spring outward against walls 84, 86, respectively, and O-ring 102 seals against an annular surface of bushing recess 82. O-rings 100, 102 contribute to an increased level of sealing between bushing 44 and housings 40, 42, which may be desirable in certain situations depending upon the flow volume and the flow viscosity. Suitable O-rings include high-temperature Viton® O-rings that are suitable for autoclaving, one source for which includes United States Plastic Corp., Lima, Ohio.

In another embodiment, O-ring 100 is seated between flanges 93, 95 and a space is provided between flanges 93, 95 and walls 74, 76, respectively, such that O-ring 100 seals the coupling along an outside diameter of O-ring 100 and enables less restrictive movement of housing 40 about bushing 44.

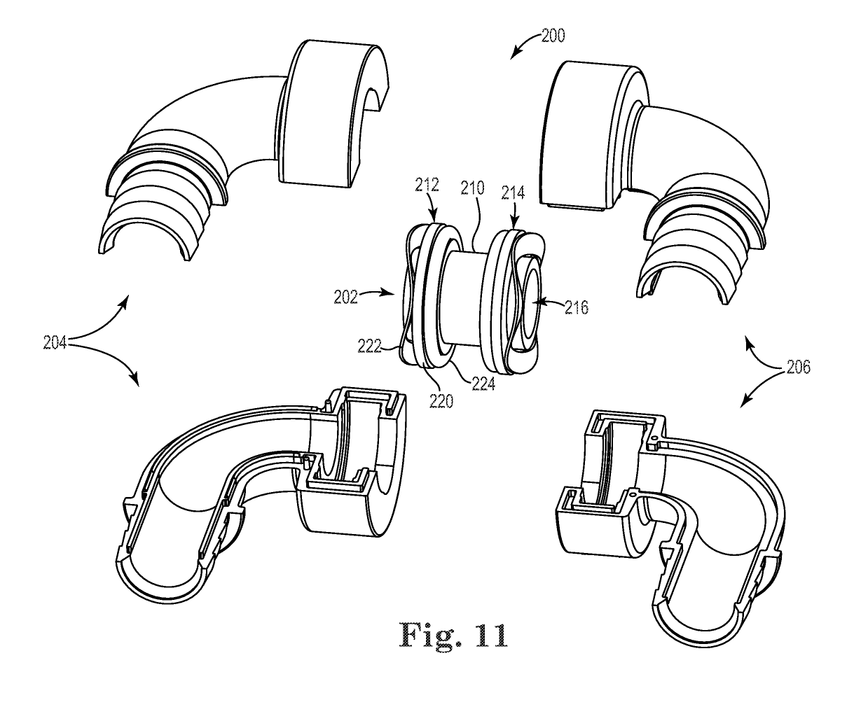

FIG. 11 is an exploded perspective view of a fluid flow coupling 200 according to another embodiment. Fluid flow coupling 200 includes a bushing 202 that is received within an inlet housing 204 and an outlet housing 206. Inlet housing 204 is similar to inlet housing 40 described above and outlet housing 206 is similar to outlet housing 42 described above. In one embodiment, bushing 202 includes an axle 210 extending between a first bushing section 212 and a second bushing section 214, where each of the bushing sections 212, 214 include a flange and a seal member.

In one embodiment, bushing 202 provides an axial flow bore 216 that combines with inlet housing 204 and outlet housing 206 to provide a substantially constant inside diameter flow path through fluid flow coupling 200, as described above. In one embodiment, first bushing section 212 includes a flange 220, a washer 222 adjacent to flange 220, and an O-ring 224 adjacent to flange 220 and opposite washer 222. In one embodiment, washer 222 is a wave washer, although other forms of washers, such as a spring washer (e.g., a conical spring washer), are also acceptable.

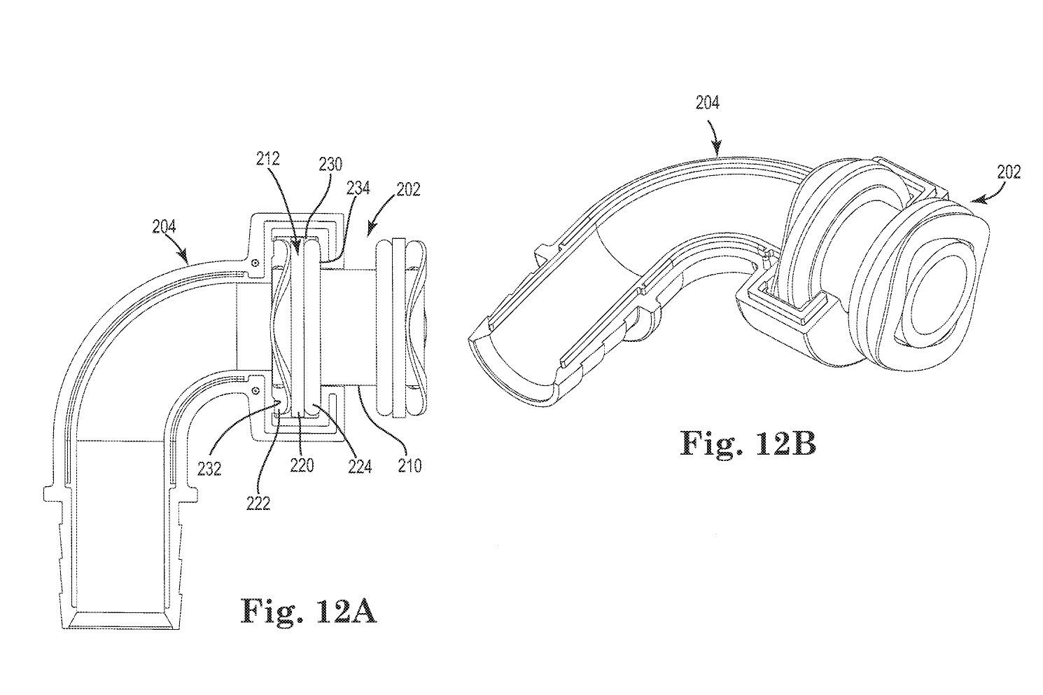

FIGS. 12A and 12B provide two views of first bushing section 212 retained within a bushing recess 230 of inlet housing 204. Washer 222 is a resilient and flexible washer configured to occupy the space between flange 220 and an interior wall 232 of bushing recess 230 and force inlet housing 204 away from outlet housing 206 such that a seal is formed between bushing sections 212, 214 as they engage with housings 204, 206. O-ring is seated between flange 220 and an opposing interior wall 234 of bushing recess 230. In this manner, bushing section 212 is sealed within bushing recess 230 and yet inlet housing 204 rotates about axle 210. Thus, the geometry of the bushing sections 212, 214 is configured to work with housings 204, 206 to form an improved seal, and yet the inlet housing 204 is free to rotate relative to the outlet housing 206.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the specific devices discussed herein.

What is claimed is:

1. A fluid flow coupling assembly comprising:
an inlet housing defining an inlet channel communicating with a first bushing recess and an outlet housing defining an outlet channel communicating with a second bushing recess;
a bushing defining a flow bore communicating between the inlet channel and the outlet channel and a first bushing section disposed in the first bushing recess and a second bushing section disposed in the second bushing recess, the inlet and outlet housings coupled to the bushing such that the inlet housing rotates about the bushing independently from the outlet housing; and
wherein the first bushing section is retained between opposing walls of the first bushing recess and the second bushing section is retained between opposing walls of the second bushing recess.

2. The fluid flow coupling assembly of claim 1, wherein the first bushing section comprises a first pair of flanges configured to flex apart to frictionally contact the opposing walls of the first bushing recess, and wherein the second bushing section comprises a second pair of flanges configured to flex apart to frictionally contact the opposing walls of the second bushing recess.

3. The fluid flow coupling assembly of claim 2, further comprising:
a first O-ring disposed between the first pair of flanges of the first bushing section and a second O-ring disposed between the second pair of flanges of the second bushing section.

4. The fluid flow coupling assembly of claim 1, wherein the inlet channel and outlet channel and the flow bore comprise substantially equal diameters.

5. The fluid flow coupling assembly of claim 1, wherein the bushing comprises an axle extending between the first bushing section and the second bushing section, and wherein the inlet housing is spaced apart from the outlet housing along the axle.

6. The fluid flow coupling assembly of claim 1, wherein an entirety of the inlet channel and outlet channel and the flow bore are linearly aligned.

7. The fluid flow coupling assembly of claim 1, wherein the first and second bushing sections each comprises a flange, an O-ring adjacent to the flange, and a washer adjacent to the flange opposite the O-ring, the O-ring and the washer configured to contact the opposing walls of the respective bushing recess.

8. The fluid flow coupling assembly of claim 7, wherein the washer comprises a resilient and flexible wave washer.

9. A fluid flow coupling assembly comprising:
a bushing including an axle extending between a first bushing section and a second bushing section and an axial flow bore extending through the bushing;
an inlet housing defining an inlet channel communicating with a first bushing recess that is configured to enclose an entirety of the first bushing section;
an outlet housing defining an outlet channel communicating with a second bushing recess that is configured to enclose an entirety of the second bushing section, the outlet housing separate from and spaced apart from the inlet housing and configured to rotate about the axle independent of the inlet housing.

10. The fluid flow coupling assembly of claim 9, wherein the first bushing section comprises a first pair of flanges configured to flex apart to frictionally contact opposing walls of the first bushing recess, and wherein the second bushing section comprises a second pair of flanges configured to flex apart to frictionally contact opposing walls of the second bushing recess.

11. The fluid flow coupling assembly of claim 10, further comprising:
a first O-ring disposed between the first pair of flanges of the first bushing section and a second O-ring disposed between the second pair of flanges of the second bushing section.

12. The fluid flow coupling assembly of claim 9, wherein the inlet channel and outlet channel and the flow bore comprise substantially equal diameters.

13. The fluid flow coupling assembly of claim 9, wherein the inlet housing is spaced apart from the outlet housing along the axle.

14. The fluid flow coupling assembly of claim 9, wherein an entirety of the inlet channel and outlet channel and the flow bore are linearly aligned.

15. The fluid flow coupling assembly of claim 9, wherein the first and second bushing sections each comprises a flange, an O-ring adjacent to the flange, and a washer adjacent to the flange opposite the O-ring, the O-ring and the washer configured to contact opposing walls of the respective bushing recess.

16. The fluid flow coupling assembly of claim 15, wherein the washer comprises a resilient and flexible wave washer.

17. A fluid flow system comprising:
a fluid flow device;
an inlet housing defining an inlet channel communicating with the fluid flow device and a first bushing recess;
an outlet housing defining an outlet channel communicating with a fluid flow source and a second bushing recess;
a bushing defining a flow bore communicating between the inlet channel and the outlet channel and including a first bushing section disposed in the first bushing recess and a second bushing section disposed in the second bushing recess, the inlet and outlet housings coupled to the bushing such that the inlet housing rotates about the bushing independently from the outlet housing; and
wherein the first bushing section is retained between opposing walls of the first bushing recess and the second bushing section is retained between opposing walls of the second bushing recess.

18. The fluid flow system of claim 17, wherein the first bushing section comprises a first pair of flanges configured to flex apart to frictionally contact opposing walls of the first bushing recess, and wherein the second bushing section comprises a second pair of flanges configured to flex apart to frictionally contact opposing walls of the second bushing recess.

19. The fluid flow system of claim 18, further comprising:
a first O-ring disposed between the first pair of flanges of the first bushing section and a second O-ring disposed between the second pair of flanges of the second bushing section.

20. The fluid flow system of claim 17, wherein the first and second bushing sections each comprises a flange, an O-ring adjacent to the flange, and a washer adjacent to the flange opposite the O-ring, the O-ring and the washer configured to contact the opposing walls of the respective bushing recess.
